(19) United States
(12) Patent Application Publication
(10) Pub. No.: US 2009/0299801 A1
(43) Pub. Date: Dec. 3, 2009

(54) To plan working hours and controlling manpower

(76) Inventors: Hilla Dayan, Rishon Letzion (IL); Eliahou Dayan, Rishon Letzion (IL)

Correspondence Address: Eliahou Dayan, Ha'Koukia Street 13/1, Rishon Letzion, 75548, IL

(21) Appl. No.: 12/214,882

(22) Filed: Jun. 24, 2008

(30) Foreign Application Priority Data
May 27, 2008 (IL) 191561

(51) Int. Cl. G06Q 10/00

(52) U.S. Cl. 705/8; 705/1

(57) ABSTRACT

The cost factor related to the number of employees is known to be the highest expenditure of a industrial firm. Hiring of workers (by skills) intended for performing work packages are done without any assessed data. This computer program/software is a very effective tool making it possible for the management of firms to control and supervise wisely their number of employees. By integrating volume of work packages will help Controlling the number of employees and re-routing them when it is necessary. As a result of discretionary planning, firms will efficiently save a great deal of money.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATED-BY-REFERENCE OF MATERIAL SUBMITTED ON COMPACT DISC

“Not Applicable”

### BACKGROUND OF THE INVENTION

A major problem of the industrial firms in the world, in many occasions, is the number of employees whether to keep, to hire, or to lay-off. It is not known one single utility tool in the industrial market that could help control and provide reasonable answer for decision makers as to how many workers are needed for projects at hand and how many more workers should be hired for near or late future. Very sound decisions can be made by planning the working hours in an efficient way which leads to controlling the number of manpower and millions of dollars are saved

### BRIEF SUMMARY OF INVENTION

This computer program/software disperses the planned working hours of all projects in a factory over time interval of projects lifetime and calculates the number of workers needed for each project and for each given period.

### BRIEF DESCRIPTION OF THE SEVERAL VIEWS OF THE DRAWINGS/FIGURES

1—FIG. (1) shows the products that are to be manufactured and for some reason the decision maker decides to slow down the rate of the production. By that decision, work packages are shifted to the right, so is the number of workers for each period of time.

2—FIG. (2) shows how the planning pages are related to loading and summary pages. This pack of pages cover data for 105 projects for seven years and seven sites (It Should be noted that all factors such as number of projects, number of sites, etc, . . . , can be extended to cover higher number, if so desired, by writing an upgrading code for this software).

3—FIG. (3) shows in more details the relations between planning pages, loading pages, and yearly summary pages (It should be noted that only the planning pages are needed to be filled by planner and the rest of the calculations are done by the program itself).

### DETAILED DESCRIPTION OF THE INVENTION

The Computer program/Software provides decision makers a useful tool to calculate and control the number of workers, by skills if so desired, needed for the work packages the firm has on hand or plan to bring in. When opening the program the first page of planning hours will be displayed (see form 1), where a planner can enter projects' hours over a period of time based on projects' lifespan. As soon as the planning is finished, the planner pushes the “start date” button and runs the program. When the program finishes running the first loading page is displayed (see form 2). The first column of this page covers 15 projects. Each project's hours has been dispersed over a planned period of time related to each project's lifespan. The second column shows the total hours of the project (if projects are in series this data can be derived from learning curves formulas that are also provided in this program/software). The third column shows the starting date of each project. The starting date is read by this program/software then each one of the planned hours for each period of the project is dispersed starting this date on. The Finish Date is optional.

Each planning page has seven loading pages. The dispersed hours are displayed on loading pages. Each loading page has time interval of twelve months. At the bottom row of each loading page, the load/capacity ratio of manpower is calculated (“load” could be total of new work packages besides work packages on hand). Usually load which is measured in manpower, is calculated by dividing the total hours of the project by 8.5 hours for each worker per day to find number of potentially needed workers, and capacity is the number of workers presently available. If the ratio load/capacity is greater than 100 then decision maker need to hire or shift workers to fulfill the need for manpower and if the ratio is less than 100 then relocation of the workers to another project may be considered.

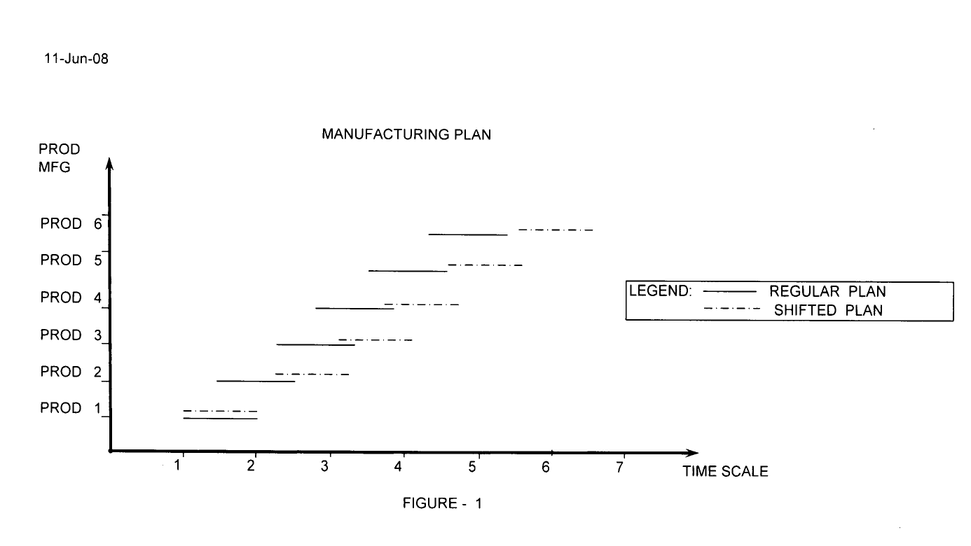

Further, if the decision maker decides to slow down the rate of production as shown in FIG. 1, by re-planning the projects hours, the number of workers that can be shifted to other plant objectives can easily be calculated.

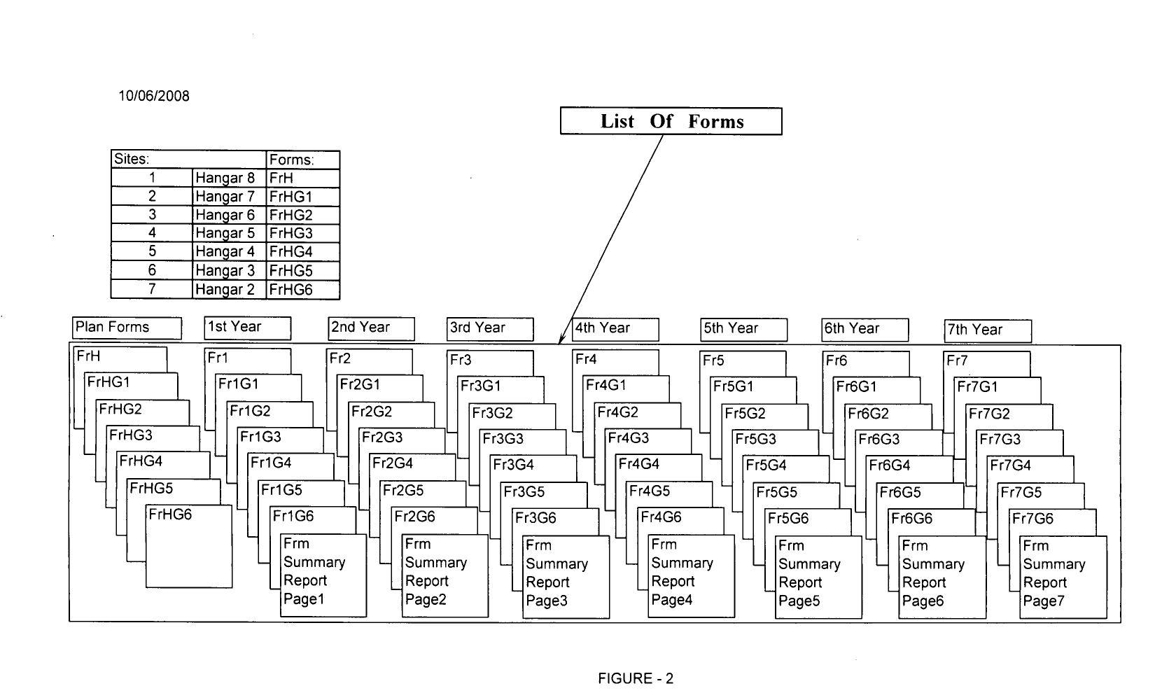

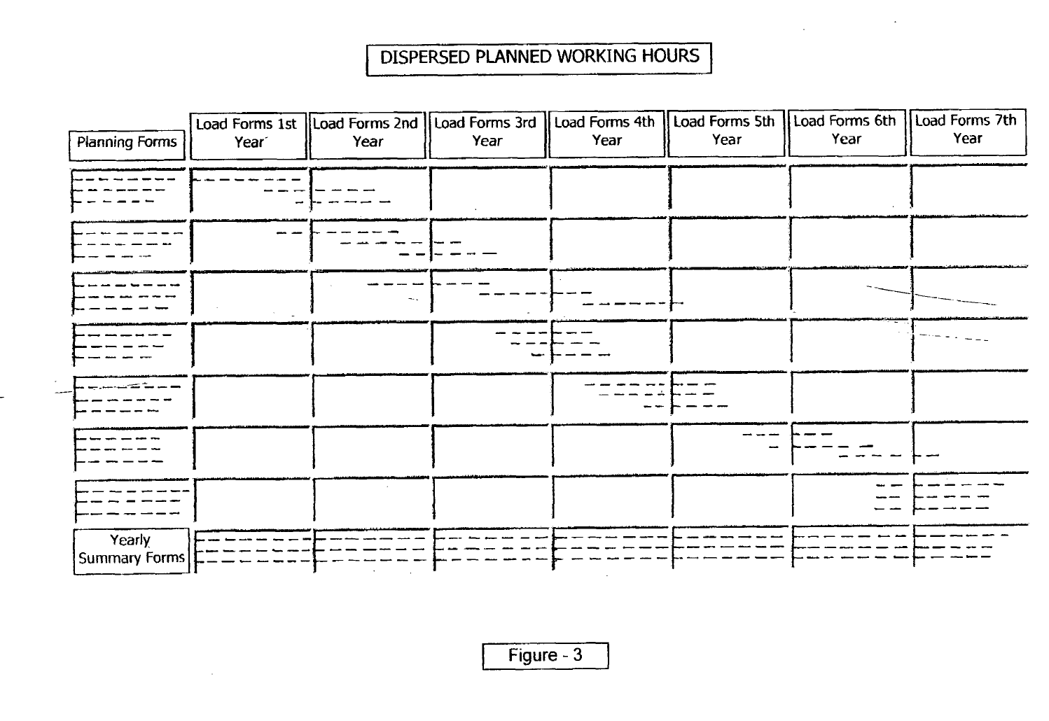

This computer program/software contains seven planning pages and each page covers a working site(Hangar or Plant etc . . . ) with 15 projects. This program can cover 105 projects for seven working sites. This computer program/software also has seven “site summary pages” (see FIGS. 2 and 3) to aggregate all sites projects hours.

Any person with some familiarity with office computer applications experience can operate this program providing 8 hours introductory course training.

Professional sectors that can benefit from this computer program/software are:
Aircraft and Aerospace Industries
Hardware Industries
Car Industries
Construction Industries
Consulting And Financial Firms
Pharmaceutal Industries
Hotel Networks
Supermarkets networks
High Tech Firms
Fast Food Chains
Municipals
Sea Ports
Small Factories
Research And Development Institutes
Army (Air Force, Navy, and Land Force)

The Computer Program/Software's capability of dispersing of the total planned working hours of a plant or projects in a industrial firm (or in any other firm that deals with a significant number of workers) over a planned time interval in order to calculate the number of workers needed for each period of time and compare it with the number of workers available. Moreover, this software makes it possible to pin point critical periods emphasizing whether more or less workers (sorted by their skills) are needed for accomplishing the work packages.

1- The Computer Program/Software as described under the title “Detailed Description of the Invention” above can integrate Learning Curves Methods and also creat/import graphs to assess the visuality and visibility of dispersed total planned working hours data.

2- Upgrading of the Computer Program/Software as described under the title “Detailed Description of the Invention” above, by using other computer programming code writing and languages to perform the same process of dispersing total planned working hours. This upgrading includes all kinds of: No of pages/forms used to display data; Creating graphs or import them from other computer applications; Calendarical dating methods and formats; Creating other capabilities to solve engineering problems; The Software is adjusted to be used as “end user” on a personal computer or loaded on a computer network of a firm as server; Adding functions or formats to print out data or e-mailing; Creating links with all other computer applications for office works.

3- Pre-calculated planning hours tables prepared for the Computer Program/Software as described under the title “Detailed Description of the Invention” above, using percentages, curves co-ordinations and/or using other factors to influence the rate of production and number of workers respectively.
